(19) United States
(12) Patent Application Publication
(10) Pub. No.: US 2025/0073827 A1
(43) Pub. Date: Mar. 6, 2025

(54) POWER-OFF PROTECTION APPARATUS AND POWER-OFF PROTECTION SYSTEM

(71) Applicant: Makeblock Co., Ltd., Shenzhen (CN)

(72) Inventors: Binquan WANG, Shenzhen (CN); Shangzheng XIE, Shenzhen (CN); Hexiang GAN, Shenzhen (CN)

(73) Assignee: Makeblock Co., Ltd., Shenzhen (CN)

(21) Appl. No.: 18/952,802

(22) Filed: Nov. 19, 2024

Related U.S. Application Data
(63) Continuation of application No. PCT/CN2023/133946, filed on Nov. 24, 2023.

(30) Foreign Application Priority Data
Nov. 26, 2022 (CN) 202211495231.5
Nov. 15, 2023 (CN) 202323090865.5

(51) Int. Cl. B23K 37/00; B23K 26/70

(52) U.S. Cl. CPC B23K 37/006; B23K 26/702

(57) ABSTRACT

A power-off protection apparatus and a power-off protection system are provided. The power-off protection apparatus is applied to the power-off protection system. The power-off protection system includes a laser machining device and a power control device. The power-off protection apparatus, the laser machining device, and the power control device are in communication connection. The laser machining device is powered on by the power control device. The power-off protection apparatus is configured to send a final encoded power-off signal to the power control device, to cause the power control device to perform a power-off operation to power off the laser machining device.

### CROSS-REFERENCE TO RELATED APPLICATION(S)

This application is continuation of International Application No. PCT/CN2023/133946, filed Nov. 24, 2023, which claims priority to Chinese patent application No. 202323090865.5, filed to the Chinese Patent Office on Nov. 15, 2023 and entitled “POWER-OFF PROTECTION APPARATUS AND POWER-OFF PROTECTION SYSTEM”, which is incorporated herein by reference in its entirety; and claims priority to Chinese patent application No. 202211495231.5, filed to the Chinese Patent Office on Nov. 26, 2022 and entitled “FIRE-EXTINGUISHING APPARATUS AND SYSTEM, POWER-OFF PROTECTION CIRCUIT, FIRE-EXTINGUISHING CONTROL METHOD, AND STATE CONTROL METHOD”, both of which are incorporated herein by reference in their entireties.

### TECHNICAL FIELD

This disclosure relates to the field of power-off protection technology, and more particularly, to a power-off protection apparatus and a power-off protection system.

### BACKGROUND

Currently, for some devices (such as a laser machining device) that are likely to burst into fire when in use, these devices, when on fire, tend to cause more serious fire if in an on-state. Therefore, a measure for protection of these devices when on fire needs to be further optimized.

### SUMMARY

In a first aspect of the disclosure, a power-off protection apparatus is provided. The power-off protection apparatus is applied to a power-off protection system. The power-off protection system includes a laser machining device and a power control device. The power-off protection apparatus, the laser machining device, and the power control device are in communication connection. The laser machining device is powered on by the power control device. The power-off protection apparatus is configured to send a final encoded power-off signal to the power control device, to cause the power control device to perform power-off operation to power off the laser machining device.

In a second aspect of the disclosure, a power-off protection system is provided. The power-off protection system includes a laser machining device, a power control device, and the foregoing power-off protection apparatus.

### BRIEF DESCRIPTION OF THE DRAWINGS

FIG. 1 is a schematic structural view of a fire-extinguishing system provided in some possible embodiments of the disclosure.

FIG. 2 is a structural block diagram of a power-off protection apparatus provided in some possible embodiments of the disclosure.

FIG. 3 is a structural block diagram of a power-off protection module provided in some possible embodiments of the disclosure.

FIG. 4 is a schematic structural diagram of an encoded-signal generation module and a wireless transmission module provided in some possible embodiments of the disclosure.

FIG. 5 is a schematic diagram of a first analog button module provided in some possible embodiments of the disclosure.

FIG. 6 is a schematic diagram of a second analog button module provided in some possible embodiments of the disclosure.

FIG. 7 is a schematic diagram illustrating modules in a power control device provided in some possible embodiments of the disclosure.

FIG. 8 is a schematic structural diagram of an encoded-signal generation module and a wireless transmission module provided in some other possible embodiments of the disclosure.

FIG. 9 is a schematic structural diagram of a decoding module and a receiving module in a power control device provided in some other possible embodiments of the disclosure.

FIG. 10 is a schematic structural diagram of an encoded-signal generation module and a wireless transmission module provided in some other possible embodiments of the disclosure.

FIG. 11 is a schematic structural diagram of a receiving module in a power control device provided in some other possible embodiments of the disclosure.

### DETAILED DESCRIPTION

The following will describe clearly and completely technical solutions of embodiments of the disclosure with reference to the accompanying drawings of the embodiments of the disclosure. Apparently, the embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

In the elaborations of the disclosure, unless specified or limited otherwise, the term “connection” should be understood in a broad sense, and may be, for example, fixed connection, detachable connection, or integral connection; or may be direct connection or indirect connection via a medium; or may be inner communication between two elements; or may be communication connection; or may be electrical connection. The meanings of the above terms in the disclosure can be understood by those of ordinary skill in the art according to specific situations.

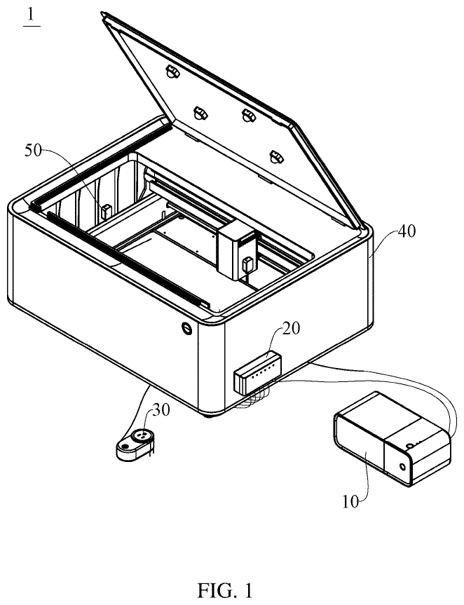

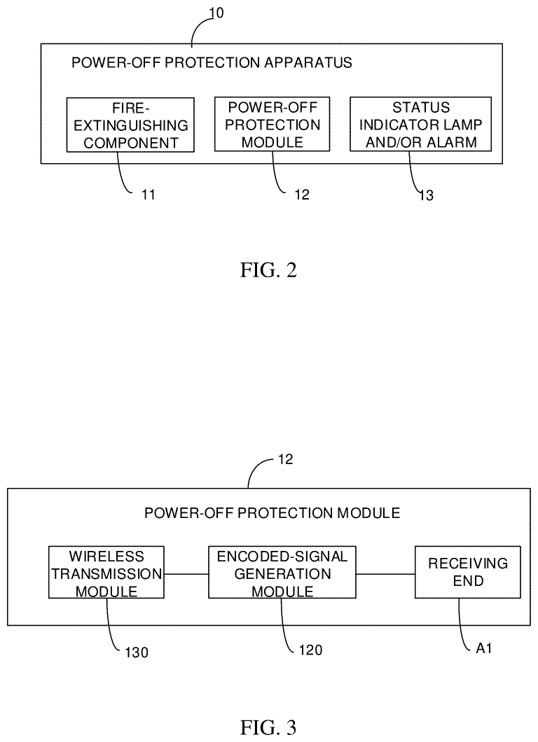

Referring to FIG. 1, FIG. 1 is a schematic structural view of a power-off protection system provided in some possible embodiments of the disclosure. FIG. 2 is a schematic diagram illustrating modules of a power-off protection apparatus provided in some possible embodiments of the disclosure.

As illustrated in FIG. 1, in some possible embodiments, the power-off protection system 1 includes a power-off protection apparatus 10, a controller 20, a power control device 30, a laser machining device 40, and a sensor 50. The sensor 50 is disposed in the laser machining device 40. The controller 20 is disposed in the laser machining device 40, or is disposed separately from the laser machining device 40. The laser machining device 40 is powered on by the power control device 30. The power-off protection apparatus 10 is in communication connection with the controller 20 and the power control device 30. The controller 20 is in communication connection with the sensor 50. The controller 20 is configured to determine whether the laser machining device 40 bursts into fire according to detection data of the sensor 50, and send a power-off control signal to the power-off protection apparatus 10 if the controller 20 determines that the laser machining device 40 bursts into fire.

It should be noted that, the sensor 50 may be disposed inside the laser machining device 40, or may be disposed inside the power-off protection apparatus 10, or may be a separately disposed sensor (however, the sensor needs to be disposed in the laser machining device 40), which is not limited herein. The controller 20 may be disposed inside the laser machining device 40, or may be disposed inside the power-off protection apparatus 10, or may be a separately disposed controller, which is not limited herein. The power control device 30 may be disposed inside the laser machining device 40, or may be a separately disposed power control device, which is not limited herein.

In the disclosure, the power-off protection system 1 includes the power-off protection apparatus 10, the controller 20, the power control device 30, the laser machining device 40, and the sensor 50. The sensor 50 is disposed in the laser machining device 40. The controller 20 is disposed in the laser machining device 40 or is disposed separately from the laser machining device 40. The laser machining device 40 is powered on by the power control device 30. The power-off protection apparatus 10 is in communication connection with the controller 20 and the power control device 30. The controller 20 sends the power-off control signal to the power-off protection apparatus 10 if the controller 20 determines that the laser machining device 40 is on fire according to the detection data of the sensor 50. In this way, when the laser machining device 40 is on fire, the power-off protection apparatus 10 can perform corresponding operation based on the power-off control signal, thereby avoiding fire spread and reduce economic loss.

In some possible embodiments, when the controller 20 is disposed separately from the laser machining device 40, the controller 20 may be disposed separately from the power-off protection apparatus 10, or may be disposed in the power-off protection apparatus 10, or may be partially disposed separately from the power-off protection apparatus 10 and partially disposed in the power-off protection apparatus 10. In other embodiments, the controller 20 may be partially disposed in the laser machining device 40 and partially disposed in the power-off protection apparatus 10.

In some possible embodiments, the power control device 30 may be disposed separately from the laser machining device 40. In other possible embodiments, the power control device 30 may be disposed on the laser machining device 40.

The controller 20 may be a single-chip microcomputer (SCM), a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof.

In some possible embodiments, the laser machining device 40 includes a laser head, and the laser head can emit a laser beam to process a material to-be-processed. The laser machining device 40 may be, but is not limited to, a laser cutting device, a plasma cutting device, a flame cutting machine, or other devices that are likely cause fire during operation. In other embodiments, the laser machining device 40 may also be a device that has safety risk when powered on.

In some possible embodiments, the sensor 50 includes a flame sensor and/or a temperature sensor. Detection data of the flame sensor and detection data of the temperature sensor are both used for determining whether the laser machining device bursts into fire. The flame sensor can sense radiant energy of the flame by using a photosensitive component (for example, a photodiode or a photoresistor) and convert the radiant energy into an electrical signal. When there is a flame, the photosensitive component can receive radiant energy of the flame, which causes change in electrical signal. The temperature sensor can perform measurement based on various principles, for example, temperature measurement with a thermistor, a thermocouple, or infrared ray, and can determine whether the laser machining device 40 bursts into fire according to a detected temperature value. It should be appreciated that, the sensor 50 may also be other sensors whose detection data can be used for determining whether there is a flame.

In some possible embodiments, the power control device 30 includes a wireless control socket. The power control device 30 is connected between a mains supply and the laser machining device 40. When the power-off control signal sent by the power-off protection apparatus 10 is received, the power control device 30 will be electrically disconnected from the laser machining device 40. The power-off protection apparatus 10 is also connected to the mains supply.

Referring to FIG. 2, FIG. 2 is a structural block diagram of a power-off protection apparatus provided in some possible embodiments of the disclosure.

In some possible embodiments, the power-off protection apparatus 10 is applied to the power-off protection system 1. The power-off protection system 1 includes the laser machining device 40 and the power control device 30. The power-off protection apparatus 10, the laser machining device 40, and the power control device 30 are in communication connection. The laser machining device 40 is powered on by the power control device 30. The power-off protection apparatus 10 is configured to send a final encoded power-off signal to the power control device 30, to cause the power control device 30 to perform power-off operation to power off the laser machining device 40.

In the disclosure, the laser machining device 40 is powered on by the power control device 30; the power-off protection apparatus 10, the laser machining device 40, and the power control device 30 are in communication connection; and the power-off protection apparatus 10 is configured to send the final encoded power-off signal to the power control device 30, so that the power control device 30 performs power-off operation to power off the laser machining device 40. As such, it is possible to prevent the laser machining device 40 from staying in an on-state which results in fire spread, thereby reducing economic loss.

The communication connection between the power-off protection apparatus 10, the laser machining device 40, and the power control device 30 may mean that the power-off protection apparatus 10 is connected to the laser machining device 40, the laser machining device 40 is connected to the power control device 30, and the power-off protection apparatus 10 is connected to the power control device 30 (connected with each other); or may mean that the power-off protection apparatus 10 is connected to the laser machining device 40, the laser machining device 40 is connected to the power control device 30, and the power-off protection apparatus 10 is connected to the power control device 30 via the laser machining device 40 (the power-off protection apparatus 10 may be connected to the power control device 30 via the laser machining device 40 when performing power-off operation). The communication connection may be wired connection or wireless connection.

In some possible embodiments, as illustrated in FIG. 2, the power-off protection apparatus 10 further includes a fire-extinguishing component 11. The fire-extinguishing component 11 communicates with a machining space inside the laser machining device, to transfer a fire-extinguishing medium to the machining space in order for fire extinguishing for the laser machining device 40. The power-off protection apparatus 10 is configured to control the fire-extinguishing component 11 to perform fire extinguishing for the laser machining device 40 when the power-off control signal is received.

In this way, the power-off protection apparatus 10 further has a function of fire extinguishing for the laser machining device 40.

In some possible embodiments, the fire-extinguishing component 11 includes a fire-extinguishing bottle and a puncturing structure. The fire-extinguishing bottle is configured to store a fire-extinguishing medium. The puncturing structure is configured to puncture the fire-extinguishing bottle to release the fire-extinguishing medium.

As such, it is more conductive to releasing quickly and conveniently the fire-extinguishing medium from the fire-extinguishing bottle.

The fire-extinguishing medium may be gas, such as carbon dioxide (CO2), heptafluoropropane (FM200), nitrogen, a mixture of inert gas, etc. The fire-extinguishing medium may also be liquid, such as water, a mixture of water and foam, liquid aerosol, etc. The fire-extinguishing medium may also be solid, such as dry ice, solid aerosol, etc.

In some possible embodiments, the power-off protection apparatus 10 includes at least one status indicator lamp and/or at least one alarm. The status indicator lamp and the at least one alarm is configured to indicate different states of the power-off protection apparatus.

As such, it is conducive to convenience for a user to know quickly the state of the power-off protection apparatus 10.

Referring to FIG. 2 and FIG. 3, FIG. 3 is a structural block diagram of a power-off protection module provided in some possible embodiments of the disclosure.

As illustrated in FIG. 2 and FIG. 3, in some possible embodiments, the power-off protection apparatus 10 further includes a power-off protection module 12. The power-off protection module 12 includes a receiving end A1, an encoded-signal generation module 120, and a wireless transmission module 130. The encoded-signal generation module 120 has one end that is connected to the receiving end A1, and the other end that is connected to the wireless transmission module 130. The receiving end A1 is configured to receive a power-off control signal. The encoded-signal generation module 120 is configured to generate a secondary encoded power-off signal based on the power-off control signal, and send the secondary encoded power-off signal to the wireless transmission module 130. The wireless transmission module 130 is configured to send the final encoded power-off signal to the power control device 30 based on the secondary encoded power-off signal, to cause the power control device 30 to perform power-off operation to power off the laser machining device 40.

As such, through wireless communication between the power-off protection module 12 and the power control device 30, the power control device 30 can perform power-off operation so as to power off the laser machining device 40.

The power control device 30 may be a socket having wireless communication functions.

The controller 20 is connected between the sensor 50 and the power-off protection module 12, and is configured to acquire fire sensing data from the sensor 50 and send the power-off control signal to the receiving end A1 if the controller 20 determines that the laser machining device 40 is on fire based on the fire sensing data. It should be noted that, for different structures of the power-off protection module 12, the power-off control signal sent by the controller 20 may be different, and the receiving end A1 may also be different. For example, when the wireless transmission module 130 in the power-off protection module 12 is a 433 megahertz (MHz) radio frequency module (a module including a 433 MHz radio frequency chip), the controller 20 may send an instantaneous high-low level signal, the receiving end A1 may be, but is not limited to, an input/output (I/O) port, and the controller 20 may be connected to the receiving end A1 via a data line. When the wireless transmission module 130 in the power-off protection module 12 is an infrared transmission module, the controller 20 may send a primary encoded power-off signal (namely, a primary encoded power-off signal consisting of a series of high and low levels), the receiving end A1 may be, but is not limited to, an I/O port, and the controller 20 may be connected to the receiving end A1 via a data line. When the wireless transmission module 130 in the power-off protection module 12 is a wireless fidelity (WiFi) radio frequency module, a Bluetooth radio frequency module, or the like, the controller 20 may send a serial peripheral interface (SPI) digital communication signal or a universal asynchronous receiver-transmitter (UART) serial communication signal, and the receiving end A1 may be, but is not limited to, an SPI interface.

In some possible embodiments, the wireless transmission module 130 includes at least one of an antenna, an infrared transmitter head, a Bluetooth wireless communication module, or a WiFi wireless communication module.

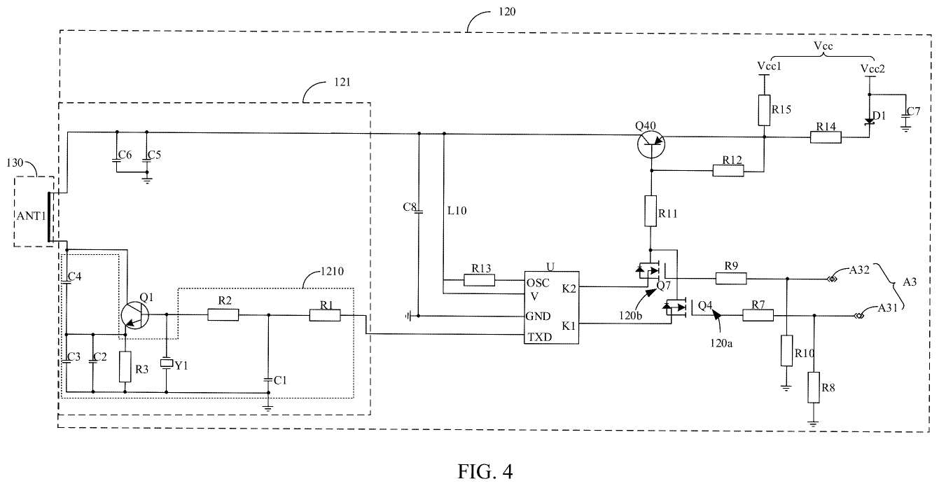

Referring to FIG. 4, FIG. 4 is a schematic structural diagram of an encoded-signal generation module and a wireless transmission module provided in some possible embodiments of the disclosure.

As illustrated in FIG. 4, in some possible embodiments, the wireless transmission module 130 includes a first antenna ANT1. The first antenna ANT1 is configured to send the final encoded power-off signal to the power control device 30 in the form of an electromagnetic wave.

Since the first antenna ANT1 sends the final encoded power-off signal to the power control device 30 in the form of an electromagnetic wave, the power control device 30 can still receive the final encoded power-off signal even though the power-off protection apparatus 10 is far away from the power control device 30.

As illustrated in FIG. 4, in some possible embodiments, the encoded-signal generation module 120 includes an encoding unit U and an encoding adjustment unit 121. The encoding unit U has one end that is connected to the receiving end A1, and the other end that is connected to the encoding adjustment unit 121. The encoding adjustment unit 121 has one end that is connected to the encoding unit U, and the other end that is connected to the wireless transmission module 130. The encoding unit U is configured to generate a corresponding primary encoded power-off signal based on the power-off control signal, and send the primary encoded power-off signal to the encoding adjustment unit 121. The encoding adjustment unit 121 is configured to generate the secondary encoded power-off signal based on the primary encoded power-off signal, and send the secondary encoded power-off signal to the wireless transmission module 130. It should be noted that, in other embodiments, the encoding unit U may generate the secondary encoded power-off signal based on the power-off control signal, and send the secondary encoded power-off signal to the wireless transmission module 130.

The encoding unit U is provided with a circuit, and can further perform programming or corresponding configuration, etc. Therefore, the corresponding primary encoded power-off signal generated by the encoding unit U has higher accuracy and higher stability.

In some possible embodiments, the encoding adjustment unit 121 further includes a first triode Q1. The first triode Q1 has a collector that is connected to the first antenna ANT1, an emitter that is grounded, and a base that is connected to the encoding unit U. The first triode Q1 is alternately in a cut-off state or an on-state under the action of the primary encoded power-off signal to generate an alternating current, so as to generate the encoded power-off signal.

In some possible embodiments, the encoding unit U includes a signal output pin TXD. The signal output pin TXD is configured to output the primary encoded power-off signal.

In this way, the encoding unit U generates the corresponding primary encoded power-off signal based on the power-off control signal, and then the first triode Q1 converts the primary encoded power-off signal into the secondary encoded power-off signal.

The primary encoded power-off signal output by the signal output pin TXD is a pulse width modulation signal.

The first antenna ANT1 has one end that is connected to a voltage end Vcc, and the other end that is connected to the collector of the first triode Q1. A current output by the voltage end Vcc is larger than a current output by the signal output pin TXD. The first triode Q1 has a function of current amplification.

When the level of the primary encoded power-off signal output by the signal output pin TXD is higher than a threshold, the first triode Q1 is switched on; and when the level of the primary encoded power-off signal output by the signal output pin TXD is lower than or equal to the threshold, the first triode Q1 is cut off. When the first triode Q1 is in the on-state, the first antenna ANT1 is grounded; and when the first triode Q1 is in the cut-off state, a voltage at the first antenna ANT1 is equal to a voltage at the voltage end Vcc, so that the secondary encoded power-off signal is actually an inverted signal of the primary encoded power-off signal.

When a voltage at the base of the first triode Q1 is higher than a voltage at the emitter of the first triode Q1, and a voltage at the collector of the first triode Q1 is higher than the voltage at the base of the first triode Q1, the first triode Q1 is switched on. The threshold may be 0 or a value greater than 0.

In some possible implementations, the encoding adjustment unit 121 further includes an oscillation tuning branch 1210. The oscillation tuning branch 1210 is configured to limit a frequency of an alternating current, to cause the first antenna ANT1 to send the final encoded power-off signal at the alternating current with the limited frequency.

The oscillation tuning branch 1210 includes a first resistor R1, a second resistor R2, a third resistor R3, a first capacitor C1, a second capacitor C2, a third capacitor C3, a fourth capacitor C4, a fifth capacitor C5, a sixth capacitor C6, and a first oscillator Y1. The first resistor R1 is connected between the signal output pin TXD and the base of the first triode Q1. The second resistor R2 is connected between the first resistor R1 and the base of the first triode Q1. The first capacitor C1 has one end that is grounded, and the other end that is connected between the first resistor R1 and the second resistor R2. The first oscillator Y1 has one end that is grounded, and the other end that is connected between the second resistor R2 and the first triode Q1. The third resistor R3 has one end that is grounded, and the other end that is connected to the emitter of the first triode Q1. The second capacitor C2 has one end that is grounded, and the other end that is connected between the emitter of the first triode Q1 and the third resistor R3. The third capacitor C3 has one end that is grounded, and the other end that is connected to the fourth capacitor C4, and the third capacitor C3 is connected in parallel with the second capacitor C2. The fourth capacitor C4 is connected between the third capacitor C3 and the first antenna ANT1, and the collector of the first triode Q1 is connected between the fourth capacitor C4 and the first antenna ANT1. The fifth capacitor C5 has one end that is grounded, and the other end that is connected between the first antenna ANT1 and a collector of a fourth triode Q40. The sixth capacitor C6 has one end that is grounded, and the other end that is connected between the first antenna ANT1 and the collector of the fourth triode Q40.

The composition of the oscillation tuning branch 1210 may be determined through test, so as to implement impedance matching with the first antenna ANT1, thereby increasing energy and reducing reflection loss of the encoded power-off signal transmitted by the first antenna ANT1.

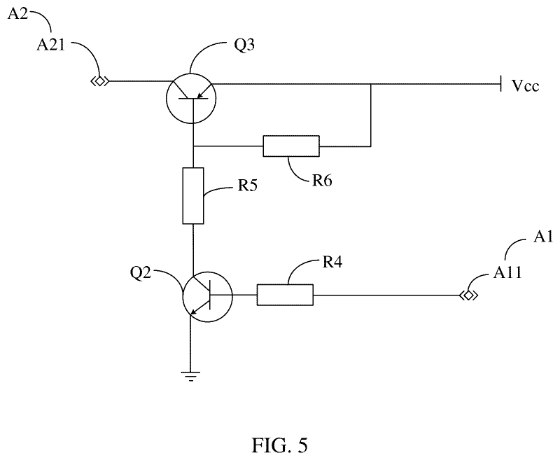

Referring to FIG. 5, FIG. 5 is a schematic diagram of a first analog button module provided in some possible embodiments of the disclosure.

As illustrated in FIG. 5, in some possible embodiments, the power-off protection module 12 further includes a first analog button module 140. The first analog button module 140 has one end that is connected to the receiving end A1, and the other end that is connected to the encoded-signal generation module 120. The first analog button module 140 is configured to amplify the power-off control signal received by the receiving end A1, and send the amplified power-off control signal to the encoded-signal generation module 120.

It should be noted that, in other embodiments, the first analog button module 140 may be omitted when a current of the power-off control signal output by the controller 20 is large enough to excite the encoding unit U to generate the primary encoded power-off signal.

In some possible embodiments, the first analog button module 140 includes a second triode Q2, a third triode Q3, a fourth resistor R4, a fifth resistor R5, a sixth resistor R6, and the first output end A21. The receiving end A1 includes a first receiving end A11. The fourth resistor R4 is connected between a base of the second triode Q2 and the first receiving end A11. The second triode Q2 has an emitter that is grounded. The fifth resistor R5 is connected between a collector of the second triode Q2 and a base of the third triode Q3. The third triode Q3 has an emitter that is connected to the voltage end Vcc, and a collector that is connected to the first output end A21. The sixth resistor R6 has one end that is connected between the collector of the second triode Q2 and the base of the third triode Q3, and has the other end that is connected between the emitter of the third triode Q3 and the voltage end Vcc. The voltage end Vcc is configured to provide a high level.

The first receiving end A11 is configured to receive the power-off control signal, so that the second triode Q2 can be switched on. The third triode Q3 can be switched on when the second triode Q2 is switched on. A voltage supplied by the voltage end Vcc (for example, 12 volts (V)) is higher than a voltage of the power-off control signal (for example, 3.3V), so as to amplify the power-off control signal received by the first receiving end A11.

As illustrated in FIG. 4, in some possible embodiments, the encoded-signal generation module 120 further includes a first button control unit 120a. The first button control unit 120a has one end that is connected to the first analog button module 140, and the other end that is connected to the encoding unit U. The first button control unit 120a is configured to power on a first detection pin K1 of the encoding unit U under the action of the amplified power-off control signal, to generate the primary encoded power-off signal.

In some possible embodiments, as illustrated in FIG. 4, the first button control unit 120a includes a first metal-oxide-semiconductor (MOS) transistor Q4. The encoding unit U includes the first detection pin K1. The first MOS transistor Q4 has a source that is connected to the first detection pin K1 and a drain that is connected to the voltage end Vcc. The voltage end Vcc is configured to provide a high level voltage. The first MOS transistor Q4 has a gate that is connected to the first analog button module 140. The first MOS transistor Q4 is switched on when the amplified power-off control signal is received by the gate of the first MOS transistor Q4, to cause the first detection pin K1 of the encoding unit U to receive a high level signal. The encoding unit U is configured to generate the primary encoded power-off signal when the high-level signal is received by the first detection pin K1.

In some possible embodiments, a voltage supplied by a first voltage end Vcc1 may be 3.3V, and a voltage supplied by a second voltage end Vcc2 may be 12V. In other embodiments, the first voltage end Vcc1 and the second voltage end Vcc2 may also provide other voltages.

An eighth resistor R8 serves as a pull-down resistor to prevent the first MOS transistor Q4 from being switched on before the amplified power-off control signal is received by the first MOS transistor Q4. An eleventh resistor R11, a twelfth resistor R12, a fourteenth resistor R14, and a fifteenth resistor R15 are used for voltage division. The first MOS transistor Q4 is switched on when the amplified power-off control signal is received by the gate of the first MOS transistor Q4, so that the fourth triode Q40 can be switched on.

In some possible embodiments, the receiving end A1 is further configured to receive a power-on control instruction. The encoded-signal generating module 120 is configured to generate an encoded power-on signal based on the power-on control instruction and send the encoded power-on signal to the wireless transmission module 130 after the power-on control instruction is received from the receiving end A1. The wireless transmission module 130 is configured to send the encoded power-on signal to the power control device 30, so as to control the power control device 30 to perform power-on operation.

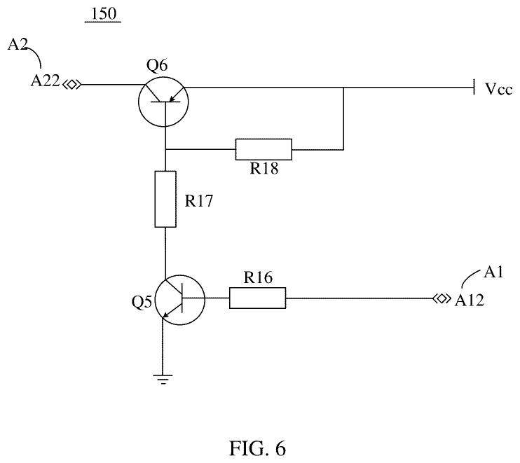

Referring to FIG. 3 and FIG. 6, FIG. 6 is a schematic diagram of a second analog button module provided in some possible embodiments of the disclosure.

As illustrated in FIG. 3 and FIG. 6, in some possible embodiments, the power-off protection module 12 further includes a second analog button module 150. The second analog button module 150 has one end that is connected to the receiving end A1, and the other end that is connected to the encoded-signal generation module 120. The second analog button module 150 is configured to amplify the power-on control instruction received by the receiving end A1, and send the amplified power-on control instruction to the encoded-signal generation module 120. The receiving end A1 includes a second receiving end A12.

In other embodiments, the power control device 30 may be provided with a power-on button. The power-on button may be operated by the user, so that the power control device 30 powers on the laser machining device 40. Therefore, the second analog button module 150 may also be omitted from the power-off protection module 12.

In some possible embodiments, the second analog button module 150 includes a fifth triode Q5, a sixth triode Q6, a sixteenth resistor R16, a seventeenth resistor R17, an eighteenth resistor R18, and a second output end A22. The sixteenth resistor R16 is connected between a base of the fifth triode Q5 and the second receiving end A12. The fifth triode Q5 has an emitter that is grounded. The seventeenth resistor R17 is connected between a collector of the fifth triode Q5 and a base of the sixth triode Q6. The sixth triode Q6 has an emitter that is connected to the voltage end Vcc, and a collector that is connected to the output end A2. The eighteenth resistor R18 has one end that is connected between the collector of the fifth triode Q5 and the base of the sixth triode Q6, and has the other end that is connected between the emitter of the sixth triode Q6 and the voltage end Vcc. The voltage end Vcc is configured to provide a high level.

As illustrated in FIG. 4, in some possible embodiments, the encoded-signal generation module 120 further includes a second button control unit 120b. The second button control unit 120b has one end that is connected to the second analog button module 150, and the other end that is connected to the encoding unit U. The second button control unit 120b is configured to power on a second detection pin K2 of the encoding unit U under the action of an amplified power-on control signal, to generate a primary encoded power-on signal.

In some possible embodiments, the second button control unit 120b includes a second MOS transistor Q7. The encoding unit U includes the second detection pin K2. The second MOS transistor Q7 has a source that is connected to the second detection pin K2 and a drain that is connected to the voltage end Vcc. The voltage end Vcc is configured to provide a high level voltage. The second MOS transistor Q7 has a gate that is connected to the second analog button module 150. The second MOS transistor Q7 is switched on when an amplified power-on control instruction is received by the gate of the second MOS transistor Q7, so that the second detection pin K2 of the encoding unit U receives a high level signal. The encoding unit U is configured to generate the primary encoded power-off signal when the high level signal is received by the second detection pin K2.

In some possible embodiments, the first button control unit 120a further includes a first signal input end A31, a seventh resistor R7, and an eighth resistor R8. The second button control unit 120b further includes a second signal input end A32, a ninth resistor R9, and a tenth resistor R10. The first button control unit 120a and the second button control unit 120b share an eleventh resistor R11, a twelfth resistor R12, a thirteenth resistor R13, a fourteenth resistor R14, a fifteenth resistor R15, the fourth triode Q40, a seventh capacitor C7, an eighth capacitor C8, and an anti-reverse diode D1. A signal input end A3 includes the first signal input end A31. The encoding unit U further includes a clock pin OSC, a ground pin GND, and a power-on pin V. The voltage end Vcc includes a first voltage end Vcc1 and a second voltage end Vcc2. The first signal input end A31 is configured to receive an amplified power-off control signal sent by the first output end A21 of the first analog button module 140. The seventh resistor R7 is connected between the gate of the first MOS transistor Q4 and the first signal input end A31. The eighth resistor R8 has one end that is grounded, and the other end that is connected between the seventh resistor R7 and the first signal input end A31. The ninth resistor R9 is connected between the gate of the second MOS transistor Q7 and the second signal input end A32. The eighth resistor R10 has one end connected between the ninth resistor R9 and the second signal input end A32, and the other end that is grounded. The drain of the second MOS transistor Q7 is connected to the drain of the first MOS transistor Q4. The eleventh resistor R11 is connected between the drain of the first MOS transistor Q4 and the base of the fourth triode Q40. The fourteenth resistor R14 is connected between the second voltage end Vcc2 and the emitter of the fourth triode Q40. The fifteenth resistor R15 is connected between the first voltage end Vcc1 and the emitter of the fourth triode Q40. The twelfth resistor R12 has one end that is connected between the base of the fourth triode Q40 and the eleventh resistor R11, and the other end that is connected to a connection intersection between the emitter of the fourth triode Q40, the fourteenth resistor R14, and the fifteenth resistor R15. The anti-reverse diode D1 is disposed between the fourteenth resistor R14 and the second voltage end Vcc2. The seventh capacitor C7 has one end that is grounded, and the other end that is connected between the anti-reverse diode D1 and the second voltage end Vcc2. The collector of the fourth triode Q40 is connected to the wireless transmission module 130. The ground pin GND is grounded. The eighth capacitor C8 has one end that is connected between the wireless transmission module 130 and the collector of the fourth triode Q40, and has the other end that is grounded. A first wire L10 has one end that is connected to the power-on pin V, and the other end that is connected between the wireless transmission module 130 and the collector of the fourth triode Q40. The thirteenth resistor R13 has one end that is connected to the clock pin OSC, and the other end that is connected to the first wire L10.

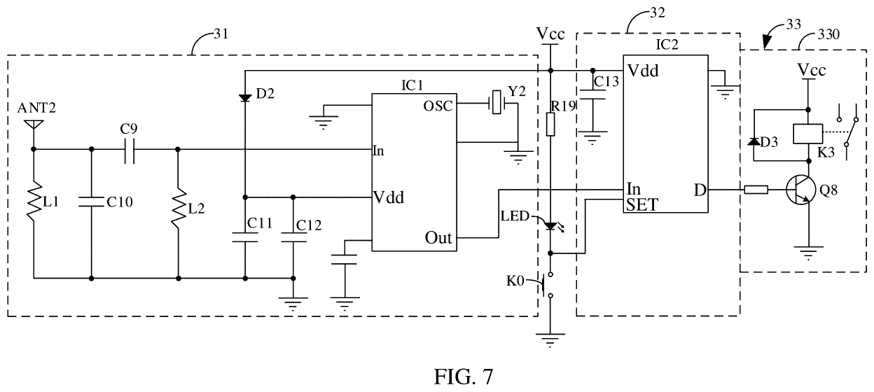

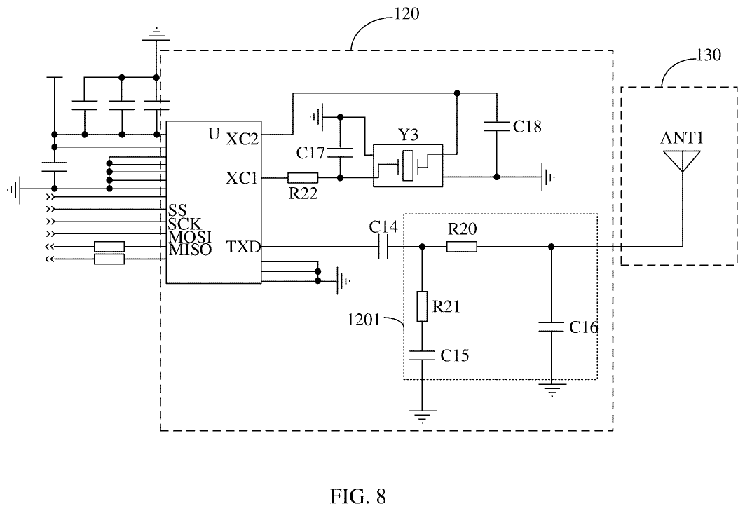

Referring to FIG. 1 and FIG. 7, FIG. 7 is a schematic diagram illustrating modules in a power control device provided in some possible embodiments of the disclosure.

As illustrated in FIG. 1 and FIG. 7, in some possible embodiments, the power control device 30 includes a receiving module 31, a decoding module 32, and a switch module 33. The receiving module 31 is configured to receive the final encoded power-off signal sent by the power-off protection module 12 in the power-off protection apparatus 10. The decoding module 32 is configured to decode the final encoded power-off signal, and control the switch module 33 based on data obtained by decoding.

In some possible embodiments, the receiving module 31 includes a second antenna ANT2, a receiving chip IC1, a first inductor L1, a ninth capacitor C9, a tenth capacitor C10, a second inductor L2, an eleventh capacitor C11, a twelfth capacitor C12, a second oscillator Y2, and a second diode D2. The receiving chip IC1 includes a signal input pin In, a signal output pin Out, a clock pin OSC, and a power-supply pin Vdd. The first inductor L1 has one end that is connected to the second antenna ANT2, and the other end that is grounded. The ninth capacitor C9 is connected between the second antenna ANT2 and the signal input pin In. The tenth capacitor C10 has one end that is connected to the second antenna ANT2, the first inductor L1, and the ninth capacitor C9, and has the other end that is grounded. The second inductor L2 is connected to the ninth capacitor C9 and the signal input pin In, and has the other end that is grounded. The second diode D2 has an anode that is connected to the voltage end Vcc, and has a cathode that is connected to the eleventh capacitor C11, the twelfth capacitor C12, and the power-supply pin Vdd. The eleventh capacitor C11 has one end that is connected to the cathode of the second diode D2 and the power-supply pin Vdd, and has the other end that is grounded. The twelfth capacitor C12 has one end that is connected to the cathode of the second diode D2, the eleventh capacitor C11, and the power-supply pin Vdd, and has the other end that is grounded. The second oscillator Y2 has one end that is connected to the clock pin OSC, and the other end that is grounded.

In some possible embodiments, the decoding module 32 includes a decoding chip IC2, an indicator lamp LED, a mode switching switch K0, a nineteenth resistor R19, and a thirteenth capacitor C13. The decoding chip IC2 includes a power-supply pin Vdd, a signal input pin In, a mode control pin SET, and at least one switch pin D. The nineteenth resistor R19, the indicator lamp LED, and the mode switching switch K0 are sequentially connected between the voltage end Vcc and the ground. The thirteenth capacitor C13 has one end that is connected to the voltage end Vcc and the power-supply pin Vdd, and has the other end that is grounded. The signal input pin In is connected to the signal output pin Out in the receiving module 31. The mode control pin SET is connected to the indicator lamp LED and the mode switching switch K0. The switch pin D is connected to the switch module 33.

The mode switching switch K0 can be operated by the user, to make the power control device 30 be in a pairing state or a working state. The power control device 30 needs to be paired with the power-off protection apparatus 10 before working.

In some possible embodiments, the switch module 33 includes at least one switch sub-module 330. Each switch sub-module 330 is connected to one switch pin D. Each switch sub-module 330 includes an eighth triode Q8, a relay switch K3, and a third diode D3. The eighth triode Q8 has a base that is connected to the switch pin D, and has an emitter that is grounded. The relay switch K3 has one end that is connected to the voltage end Vcc, and the other end that is connected to a collector of the eighth triode Q8. The third diode D3 has an anode that is connected to the collector of the eighth triode Q8, and has a cathode that is connected to the voltage end Vcc.

The power control device 30 may be electrically connected to at least one laser machining device 40. When the power control device 30 is electrically connected to one laser machining device 40, after the decoding chip IC2 obtains the power-off signal by decoding, the switch pin D outputs a high-level signal to switch on the eighth transistor Q8 and switch off the relay switch K3, so that the power control device 30 is electrically disconnected from the laser machining device 40. When the power control device 30 is electrically connected to multiple laser machining devices 40, after the decoding chip IC2 obtains the power-off signal by decoding, a corresponding switch pin D is controlled to output a high-level signal, to switch on a corresponding eighth triode Q8 and switch off a corresponding relay switch K3, so that the power control device 30 is electrically disconnected from a corresponding laser machining device 40.

Referring to FIG. 8, FIG. 8 is a schematic structural diagram of an encoded-signal generation module and a wireless transmission module provided in some other possible embodiments of the disclosure.

Similar to the foregoing embodiments, in other possible embodiments, as illustrated in FIG. 8, the difference lies in that the encoding adjustment unit 121 further includes a fourteenth capacitor C14. The encoding unit U includes the signal output pin TXD. The signal output pin TXD is configured to output the primary encoded power-off signal. The fourteenth capacitor C14 is connected to the signal output pin TXD and the wireless transmission module 130. The fourteenth capacitor C14 is configured to convert the primary encoded power-off signal into the secondary encoded power-off signal.

The primary encoded power-off signal may be a pulse width modulation signal. When the signal output pin TXD outputs a high level, the fourteenth capacitor C14 is charged; and when the signal output pin TXD outputs a low level, the fourteenth capacitor C14 is discharged, so that the secondary encoded power-off signal is an inverted level signal of the primary encoded power-off signal.

In other possible embodiments, the encoded-signal generation module 120 further includes an impedance matching branch 1201. The impedance matching branch 1201 is configured to perform impedance matching with an antenna.

In other possible embodiments, the impedance matching branch 1201 includes a twentieth resistor R20, a twenty-first resistor R21, a fifteenth capacitor C15, and a sixteenth capacitor C16. The twentieth resistor R20 is connected to the fourteenth capacitor C14 and the first antenna ANT1. The twenty-first resistor R21 has one end that is connected to the fourteenth capacitor C14 and the twentieth resistor R20, and has the other end that is connected to the fifteenth capacitor C15. The fifteenth capacitor C15 has one end that is grounded. The sixteenth capacitor C16 has one end that is connected to the twentieth resistor R20 and the first antenna ANT1, and has the other end that is grounded.

The impedance matching branch 1201 can be adjusted through testing, so as to match an impedance of the first antenna ANT1, thereby increasing energy and reducing reflection loss of the final encoded power-off signal transmitted by the first antenna ANT1.

In other possible embodiments, the encoding unit U communicates with the controller by means of SPI. Therefore, the encoding unit U further includes a serial clock (SCK) pin, a master out slave in (MOSI) pin, a master in slave out (MISO) pin, and a slave select (SS) pin.

In other possible embodiments, the encoding unit U further includes a first clock pin XC1 and a second clock pin XC2. The encoded-signal generation module 120 further includes a third oscillator Y3, a twenty-second resistor R22, a seventeenth capacitor C17, and an eighteenth capacitor C18. The twenty-second resistor R22 has one end that is connected to the first clock pin XC1, and the other end that is connected to the third oscillator Y3. The seventeenth capacitor C17 has one end that is connected to the twenty-second resistor R22 and the third oscillator Y3, and has the other end that is connected to the third oscillator Y3 and grounded. The second clock pin XC2 is connected to one end of the third oscillator Y3 and one end of the eighteenth capacitor C18, and the eighteenth capacitor C18 has the other end that is connected to the third oscillator Y3 and grounded.

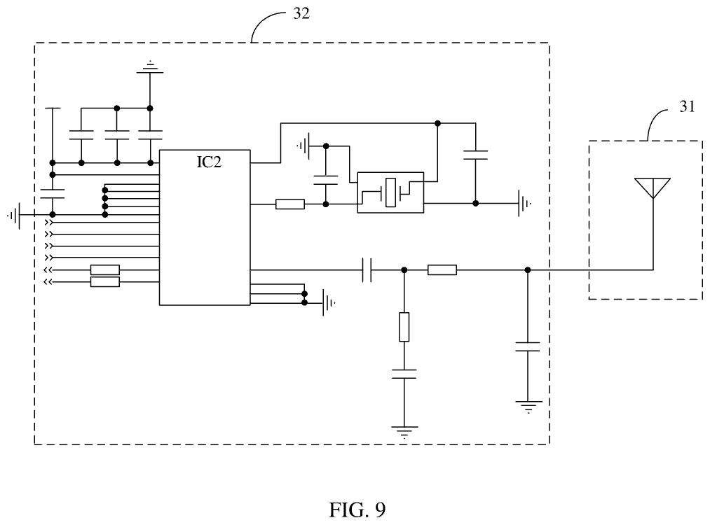

As illustrated in FIG. 9, FIG. 9 is a schematic structural diagram of a decoding module and a receiving module in a power control device provided in some other possible embodiments of the disclosure.

As illustrated in FIG. 9, in other possible embodiments, the power control device 30 is provided with a module having a structure similar to that of the power-off protection module 12 in the power-off protection apparatus 10, where the module is configured to receive and decode the final encoded power-off signal sent by the power-off protection module 12. The decoding module 32 in the power control device 30 has a structure similar to that of the encoded-signal generation module 120 in the power-off protection module 12 (the decoding chip IC2 in the decoding module 32 is configured to decode the final encoded power-off signal, and the encoding unit U in the encoded-signal generation module 120 is configured to encode to generate the primary encoded power-off signal). The receiving module 31 in the power-off control device 30 has a structure similar to that of the wireless transmission module 130 in the power-off protection module 12 (the second antenna ANT2 in the receiving module 31 is configured to receive the final encoded power-off signal, and the first antenna ANT1 in the wireless transmission module 130 is configured to send the final encoded power-off signal).

In this way, the power control device 30 can receive the final encoded power-off signal sent by the power-off protection module 12 in the power-off protection apparatus 10, and decode the final encoded power-off signal. As such, the power-off protection apparatus 10 can send the final encoded power-off signal to the power control device 30, and then the power-controlled device 30 can perform power-off operation so as to be electrically disconnected from the laser machining device 40.

In the embodiments, the decoding chip IC2 in the decoding module 32 may be the same as or different from the decoding chip IC2 in some possible embodiments.

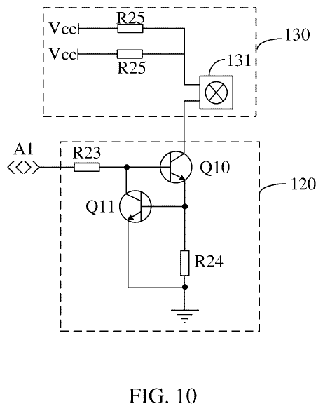

Referring to FIG. 10, FIG. 10 is a schematic structural diagram of an encoded-signal generation module and a wireless transmission module provided in some other possible embodiments of the disclosure.

Similar to the foregoing embodiments, in some other possible embodiments, as illustrated in FIG. 10, the difference lies in that the wireless transmission module 130 includes an infrared transmitter head 131. The infrared transmitter head 131 is configured to send the final encoded power-off signal to the power-control device 30.

The infrared transmitter head 131 can convert an electrical signal into an infrared optical signal, so as to transmit wirelessly the final encoded power-off signal to the power-controlled device 30 in the form of infrared light.

In some other possible embodiments, the encoded-signal generation module 120 includes a tenth triode Q10. The tenth triode Q10 has a base that is connected to the encoding unit U, has an emitter that is grounded, and has a collector that is connected to one end of the infrared transmitter head 131, and the infrared transmitter head 131 has the other end that is connected to the voltage end Vcc. The tenth triode Q10 is alternately in a cut-off state or an on-state under the action of the power-off control signal, to generate the secondary encoded power-off signal.

The encoding unit U may be disposed in the power-off protection apparatus, and the encoding unit U may be an encoding chip, a controller, or the like. The controller may be, but is not limited to, an SCM, an integrated circuit, etc.

In some other possible embodiments, the encoded-signal generation module 120 further includes a twenty-third resistor R23, a twenty-fourth resistor R24, a twenty-fifth resistor R25, and an eleventh triode Q11. The twenty-third resistor R23 has one end that is connected to the receiving end A1, and the other end that is connected to a base of the tenth triode Q10. The twenty-fourth resistor R24 has one end that is connected to an emitter of the tenth triode Q10, and the other end that is grounded. The eleventh triode Q11 has a base that is connected to the emitter of the tenth triode Q10 and the twenty-fourth resistor R24, has an emitter that is grounded, and has a collector that is connected to the twenty-third resistor R23 and the base of the tenth triode Q10. The twenty-fifth resistor R25 has one end that is connected to the voltage end Vcc, and the other end that is connected to the infrared transmitter head 131.

When the wireless transmission module 130 includes the infrared transmission head 131, in order to improve reliability of communication, multiple power-off protection modules 12 can be provided, and accordingly, one or more modules corresponding to the power-off protection modules 12 can also be provided in the power-control device 30.

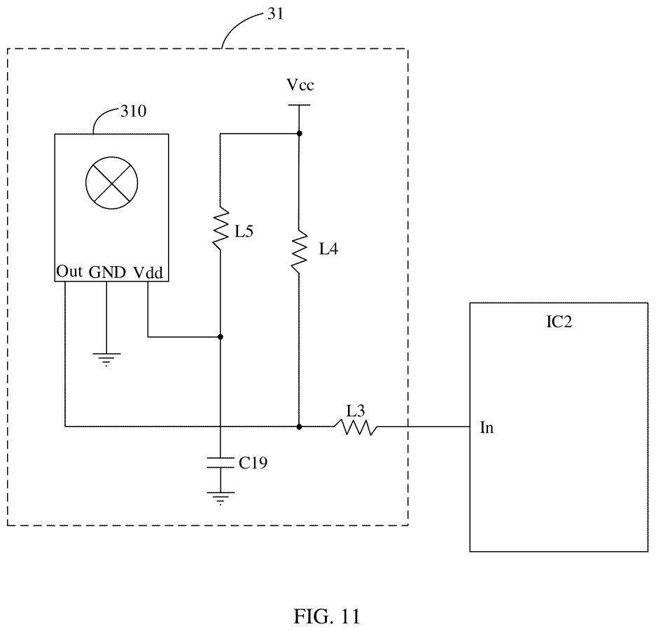

Referring to FIG. 11, FIG. 11 is a schematic structural diagram of a receiving module in a power control device provided in some other possible embodiments of the disclosure.

In some other possible embodiments, as illustrated in FIG. 11, the receiving module 31 in the power control device 30 includes an infrared receiver head 310, a third inductor L3, a fourth inductor LA, a fifth inductor L5, and a nineteenth capacitor C19. The infrared receiver head 310 includes a power-supply pin Vdd, a signal output pin Out, and a ground pin GND. The decoding chip IC2 includes a signal input pin In. The third inductor L3 is connected to the signal output pin Out and the signal input pin In. The fourth inductor L4 has one end that is connected to the voltage end Vcc, and the other end that is connected to the signal output pin Out and the third inductor L3. The fifth inductor L5 has one end that is connected to the voltage end Vcc, and the other end that is connected to the power-supply pin Vdd and one end of the nineteenth capacitor C19, and the nineteenth capacitor C19 has the other end that is grounded.

It should be noted that, the structure of modules in the decoding chip IC2 in the embodiments may be the same as or different from that of the decoding chip IC2 in some possible embodiments. The decoding module 32 and the switch module 33 in the power control device 30 in the embodiments may be the same as or different from those in the foregoing embodiments.

It should be noted that, in the foregoing embodiments, voltages provided by voltage ends Vcc in various modules may be the same or different.

In the foregoing embodiments, the elaboration of each embodiment has its own emphasis. For the part not described in detail in an embodiment, reference can be made to related elaborations in other embodiments.

The above is implementations of the embodiments of the disclosure. It should be noted that, those of ordinary skill in the art can also make improvements and modifications without departing from the principle of the embodiments of the disclosure, and these improvements and modifications shall also belong to the protection scope of the disclosure.

I/We claim:

1. A power-off protection apparatus, applied to a power-off protection system; the power-off protection system comprising a laser machining device and a power control device, the power-off protection apparatus, the laser machining device, and the power control device being in communication connection, and the laser machining device being powered on by the power control device; and the power-off protection apparatus being configured to send a final encoded power-off signal to the power control device, to cause the power control device to perform power-off operation to power off the laser machining device.

2. The power-off protection apparatus of claim 1, further comprising:
a fire-extinguishing component communicating with a machining space inside the laser machining device to transfer a fire-extinguishing medium to the machining space in order for fire extinguishing for the laser machining device.

3. The power-off protection apparatus of claim 2, wherein the fire-extinguishing component comprises:
a fire-extinguishing bottle configured to store fire-extinguishing medium; and
a puncturing structure configured to puncture the fire-extinguishing bottle to release the fire-extinguishing medium.

4. The power-off protection apparatus of claim 1, further comprising:
at least one status indicator lamp and/or at least one alarm configured to indicate different states of the power-off protection apparatus.

5. The power-off protection apparatus of claim 1, wherein
the power-off protection apparatus further comprises a power-off protection module, the power-off protection module comprises a receiving end, an encoded-signal generation module, and a wireless transmission module; the encoded-signal generation module has one end that is connected to the receiving end and the other end that is connected to the wireless transmission module; and
the receiving end is configured to receive a power-off control signal, the encoded-signal generation module is configured to generate a secondary encoded power-off signal based on the power-off control signal and send the secondary encoded power-off signal to the wireless transmission module, and the wireless transmission module is configured to send the final encoded power-off signal to the power control device based on the secondary encoded power-off signal, to cause the power control device to perform power-off operation to power off the laser machining device.

6. The power-off protection apparatus of claim 5, wherein the encoded-signal generation module comprises an encoding unit and an encoding adjustment unit, the encoding unit has one end that is connected to the receiving end and the other end that is connected to the encoding adjustment unit, the encoding adjustment unit has one end that is connected to the encoding unit and the other end that is connected to the wireless transmission module, the encoding unit is configured to generate a corresponding primary encoded power-off signal based on the power-off control signal and send the primary encoded power-off signal to the encoding adjustment unit, and the encoding adjustment unit is configured to generate an encoded power-off signal based on the primary encoded power-off signal and send the encoded power-off signal to the wireless transmission module.

7. The power-off protection apparatus of claim 6, wherein the encoding adjustment unit comprises a triode, the triode has a collector that is connected to the wireless transmission module, has an emitter that is grounded, and has a base that is connected to the encoding unit, and the triode is alternately in a cut-off state or an on-state under the action of the primary encoded power-off signal to generate an alternating current, to generate the encoded power-off signal.

8. The power-off protection apparatus of claim 6, wherein the power-off protection apparatus further comprises a first analog button module, the first analog button module has one end that is connected to the receiving end and the other end that is connected to the encoded-signal generation module, and the first analog button module is configured to amplify the power-off control signal received by the receiving end and send the amplified power-off control signal to the encoded-signal generation module.

9. The power-off protection apparatus of claim 8, wherein the encoded-signal generation module further comprises a first button control unit, the first button control unit has one end that is connected to the first analog button module and the other end that is connected to the encoding unit, and the first button control unit is configured to power on a first detection pin of the encoding unit under the action of the amplified power-off control signal, to generate the primary encoded power-off signal.

10. The power-off protection apparatus of claim 9, wherein the first button control unit comprises a first metal-oxide-semiconductor (MOS) transistor, the encoding unit further comprises the first detection pin; the first MOS transistor has a source that is connected to the first detection pin and a drain that is connected to a voltage end, and the voltage end is configured to provide a high level voltage; the first MOS transistor has a gate that is connected to the first analog button module; the first MOS transistor is switched on when the amplified power-off control signal is received by the gate of the first MOS transistor, to cause the first detection pin of the encoding unit to receive a high level signal, and the encoding unit is configured to generate the primary encoded power-off signal when the high level signal is received by the first detection pin.

11. The power-off protection apparatus of claim 6, wherein
the encoding adjustment unit further comprises an oscillation tuning branch, and the oscillation tuning branch is configured to limit a frequency of an alternating current, to cause the wireless transmission module to send the final encoded power-off signal at the alternating current with the limited frequency; and/or
the encoding adjustment unit comprises a capacitor, the encoding unit comprises a signal output pin, and the signal output pin is configured to output the primary encoded power-off signal; the capacitor is connected to the signal output pin and the wireless transmission module, and the capacitor is configured to convert the primary encoded power-off signal into the secondary encoded power-off signal; and/or
the encoding adjustment unit further comprises an impedance matching branch, and the impedance matching branch is configured to perform impedance matching with an antenna.

12. The power-off protection apparatus of claim 6, wherein the power-off protection apparatus further comprises a second analog button module, the second analog button module has one end that is connected to the receiving end and the other end that is connected to the encoded-signal generation module, and the second analog button module is configured to amplify a power-on control signal received by the receiving end and send the amplified power-on control signal to the encoded-signal generation module.

13. The power-off protection apparatus of claim 12, wherein the encoded-signal generation module further comprises a second button control unit, the second button control unit has one end that is connected to the second analog button module and the other end that is connected to the encoding unit, the second button control unit is configured to power on a second detection pin of the encoding unit under the action of the amplified power-on control signal, to generate a primary encoded power-on signal.

14. A power-off protection system, comprising a laser machining device, a power control device, and a power-off protection apparatus; the laser machining device, and the power control device being in communication connection, and the laser machining device being powered on by the power control device; and the power-off protection apparatus being configured to send a final encoded power-off signal to the power control device, to cause the power control device to perform power-off operation to power off the laser machining device.

15. The power-off protection system of claim 14, wherein
the power-off protection apparatus comprises a power-off protection module, the power-off protection module comprises a receiving end, an encoded-signal generation module, and a wireless transmission module; the encoded-signal generation module has one end that is connected to the receiving end and the other end that is connected to the wireless transmission module; and
the receiving end is configured to receive a power-off control signal, the encoded-signal generation module is configured to generate a secondary encoded power-off signal based on the power-off control signal and send the secondary encoded power-off signal to the wireless transmission module, and the wireless transmission module is configured to send the final encoded power-off signal to the power control device based on the secondary encoded power-off signal, to cause the power control device to perform power-off operation to power off the laser machining device.

16. The power-off protection system of claim 15, wherein the encoded-signal generation module comprises an encoding unit and an encoding adjustment unit, the encoding unit has one end that is connected to the receiving end and the other end that is connected to the encoding adjustment unit, the encoding adjustment unit has one end that is connected to the encoding unit and the other end that is connected to the wireless transmission module, the encoding unit is configured to generate a corresponding primary encoded power-off signal based on the power-off control signal and send the primary encoded power-off signal to the encoding adjustment unit, and the encoding adjustment unit is configured to generate an encoded power-off signal based on the primary encoded power-off signal and send the encoded power-off signal to the wireless transmission module.

17. The power-off protection system of claim 16, wherein the power-off protection apparatus further comprises a first analog button module, the first analog button module has one end that is connected to the receiving end and the other end that is connected to the encoded-signal generation module, and the first analog button module is configured to amplify the power-off control signal received by the receiving end and send the amplified power-off control signal to the encoded-signal generation module;
the encoded-signal generation module further comprises a first button control unit, the first button control unit has one end that is connected to the first analog button module and the other end that is connected to the encoding unit, and the first button control unit is configured to power on a first detection pin of the encoding unit under the action of the amplified power-off control signal, to generate the primary encoded power-off signal.

18. The power-off protection system of claim 14, wherein the power control device comprises a receiving module, a decoding module, and a switch module, the receiving module is configured to receive a final encoded power-off signal sent by the power-off protection apparatus, and the decoding module is configured to decode the final encoded power-off signal, and control the switch module based on data obtained by decoding.

19. The power-off protection system of claim 14, wherein the laser machining device comprises a laser head, and the laser head can emit a light beam to process a material to-be-processed.

20. The power-off protection system of claim 19, wherein
the power-off protection system comprises a sensor, and the sensor comprises a flame sensor and/or a temperature sensor; and/or
the power-off protection system comprises a controller and a sensor, the controller is in communication connection with the sensor, and the controller is configured to determine whether the laser machining device bursts into fire according to detection data of the sensor, and configured to send a power-off control signal to the power-off protection apparatus; and/or
the power control device comprises a wireless control socket.
